(19) United States
(12) Patent Application Publication
(10) Pub. No.: US 2016/0301349 A1
(43) Pub. Date: Oct. 13, 2016

(54) HOUSEHOLD APPLIANCE WITH MULTIPLE SYNCHRONOUS MOTORS AND CONTROL CIRCUIT THEREOF

(71) Applicant: ARCELIK ANONIM SIRKETI, Istanbul (TR)

(72) Inventor: Latif TEZDUYAR, Istanbul (TR)

(21) Appl. No.: 15/100,336

(22) PCT Filed: Nov. 29, 2013
(86) PCT No.: PCT/EP2013/075079

§ 371 Date: May 30, 2016

(51) Int. Cl. H02P 27/04; D06F 58/28; D06F 29/00; D06F 33/02; A47L 15/00

(52) U.S. Cl. CPC H02P 27/04; D06F 33/02; A47L 15/0018; D06F 29/005; D06F 58/28; D06F 2202/12; D06F 2204/065; D06F 2204/084

(57) ABSTRACT

The present invention relates to an electrical household appliance comprising an electronic control board (3) effecting functions of said electrical household appliance and a discharge pump (1), said discharge pump (1) being driven by an electric motor powered by said electronic control board (3) by means of a first switching device (2), the electrical household appliance further comprising a pump driver board (4) controlling the speed of said electric motor by means of a power driver circuit (7) and being powered by the electronic control board (3) by means of the first switching device (2).

The present invention relates to an electrical household appliance having a discharge (drain) pump with an improved control circuit topology.

It is well-known that synchronous motors and brushless DC motors are widely used in rotary household appliances and especially in dishwashers and laundry treatment appliances. For instance, a laundry treatment appliance, likewise a dishwasher, does have a discharge (drain) pump for discharging the water contained in the drum.

A synchronous machine is an electrical machine with a rotating stator magnetic flux and a rotor flux locked therewith to rotate in the synchronous frequency. It requires a speed control circuit topology in which an inverter with multiple power switches is present. The inverter's role is to dynamically control the synchronous motor's speed during starting up as well as other instances where variable speed is desirable. For instance, the speed of a discharge pump motor in a washing machine needs to be decreased if the amount of water in circulation is not adequate and the pump is likely to start pumping air mixed with water. This can eventually lead to generation of an uncontrolled amount of sound to the extent that customer complaints may need to be addressed. Accordingly, a synchronous motor pump that is being driven in constant speed involves the disadvantage of uncontrolled sound generation. On the other hand, a brushless DC motor is also suitable for performing speed control due to the simplicity of the electronic control circuitry.

To this end, the electronic control board of an electrical household appliance only powering a synchronous motor discharge pump on and off by means of a triac circuit requires substantive modification in order for applying variable speed control to the synchronous machine. Therefore, it is desirable to obtain a circuit arrangement which allows variable speed control without modifying the main electronic control board, which would otherwise require replacement of the simple, reliable and cost-effective triac circuit with a more sophisticated circuit design so as to involve comprehensive change of the existing electronic control board itself.

Among others, one of the prior art disclosures in the technical field of the present invention can be referred to as EP 0574823, which defines a device for starting a permanent magnet synchronous motor, the device having a static power switch and a triac arranged in series between the stator winding of the motor and the alternating-voltage source at mains frequency. The triac is controlled by an electronic circuit which processes the current flowing through the coil of the synchronous motor, the position and polarity of the permanent magnet of the rotor, and the polarity of the alternating-voltage source.

The present invention provides an electrical household appliance and particularly a laundry treatment appliance or a dishwasher, having a main electronic control board and a discharge pump, said electronic control board having a triac circuit suitable for powering said discharge pump on and off but also suitable for powering a pump control board applying variable speed control to the pump motor.

The present invention provides a pump driver board supplied by a triac circuit of a main electronic control board so as to draw a minimum amount of current on a continual basis during conduction of the triac as provided by the characterizing features defined in claim 1.

Primary object of the present invention is therefore to provide an electrical household appliance with an electronic control board designed to apply on/off switching control to a discharge pump by means of an AC switch, i.e. a triac for alternating current, and which is also capable of driving a pump driver board by said triac.

The present invention proposes an electrical household appliance comprising an electronic control board and a discharge pump. Said discharge pump is discontinuously powered at intervals by means of a triac on the board. A pump driver board having a power driver circuit controls the speed and also self-starting of the pump motor. Said pump driver board comprises a controllable load circuit that draws a certain, predetermined amount of current while said triac is turned on by the main board and while the pump motor is operated at intervals.

The controllable load circuit also has a switching device In series with a current limiting resistance and it is turned on and off in response to the operational state of the discharge pump when said triac is triggered and remains In conduction.

Accompanying drawings are given solely for the purpose of exemplifying a driver control circuit topology whose advantages over prior art were outlined above and will be explained in brief hereinafter.

The drawings are not meant to delimit the scope of protection as identified in the claims nor should they be referred to alone in an effort to interpret the scope identified In said claims without recourse to the technical disclosure in the description of the present invention.

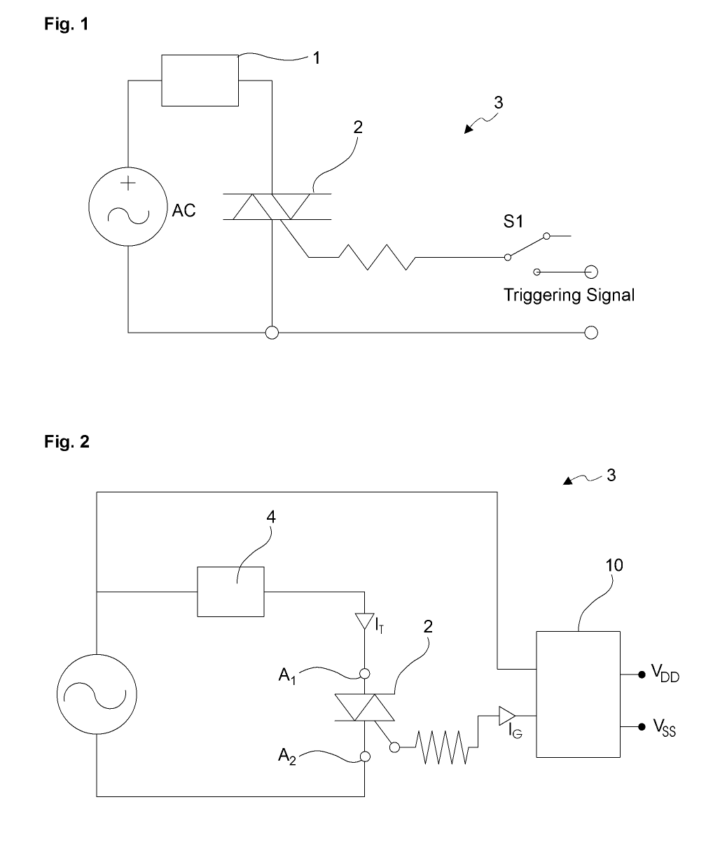

FIG. 1 demonstrates a general schematic circuit diagram of an electronic control board conventionally having a triac in order for powering on and off a discharge pump.

FIG. 2 demonstrates a more detailed schematic circuit diagram of the electronic control board of FIG. 1.

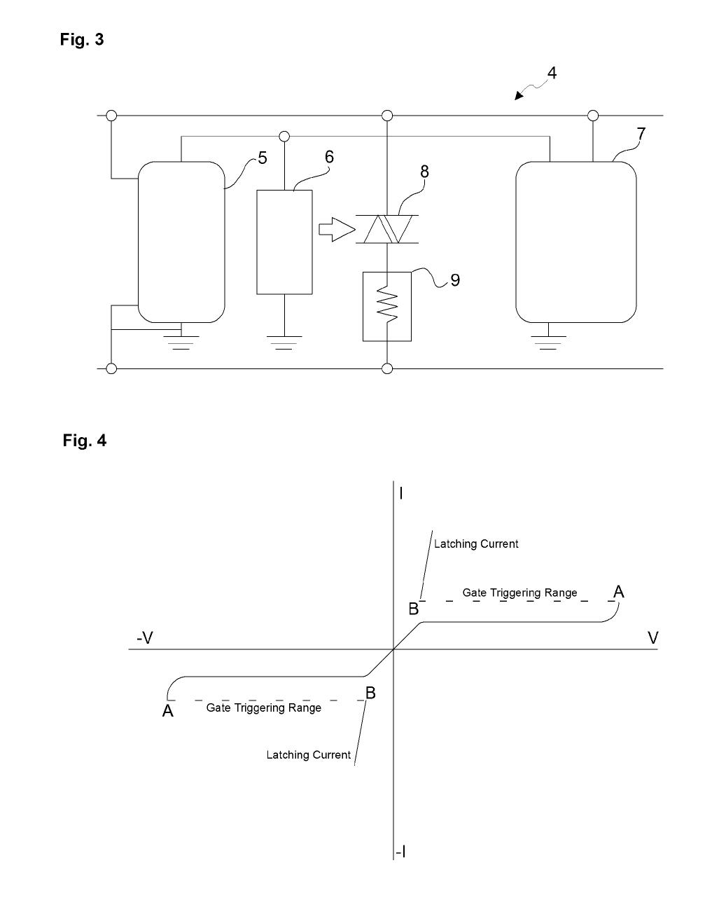

FIG. 3 demonstrates a pump driver board according to the present invention.

FIG. 4 demonstrates the I-V curve characteristic of a triac for alternating current.

The following numerals are used in the detailed description:

1. Discharge pump

2. First switching device

3. Electronic control board

4. Pump driver board

5. Power supply stage

6. Microcontroller

7. Power driver circuit

8. Second switching device

9. Current limiting resistance

10. Main board microcontroller

The present invention proposes an electrical household appliance and particularly a washing machine, a dishwasher, a drying machine or a combo drying and washing machine. The electrical household appliance comprises an electric motor and preferably a synchronous electric motor that could be a permanent magnet or wound rotor synchronous motor or a brushless DC motor, an electronic control board (3) for powering said electric motor and a pump driver board (4) that is capable of controlling the speed of said electric motor. Said motor in the household appliance is preferably a discharge pump (1) motor functional in discharging the water used in the appliance after a certain processing task associated with the appliance is completed. The pump driver board (4) has a power supply stage (5) and a power driver circuit (7). The power driver circuit (7) of the pump driving board (4) can be realized by means of an inverter or in any other topology to apply speed control to a synchronous motor pump. The same analogy applies in that the power driver circuit (7) can be designed to perform variable speed control for a brushless DC motor. In a nutshell, the present invention proposes an electrical household appliance comprising an electronic control board (3) effecting functions of said electrical household appliance and a discharge pump (1), said discharge pump (1) being driven by an electric motor powered by said electronic control board (3) by means of a first switching device (2), said electrical household appliance further comprising a pump driver board (4) controlling the speed of said electric motor by means of a power driver circuit (7) and being powered by said electronic control board (3) by means of said first switching device (2).

In an embodiment of the present invention, the first switching device (2) of the electronic control board (3) is a triac that is switched on and off by the main board microcontroller (10) of the electronic control board (3) based on a preconfigured look-up table.

In order for employing a conventional electronic control board (3) having a triac as a first switching device (2) in control of a pump driver board (4), the pump driver board (4) comprises a controllable load circuit operable to conduct a controllable-load current so as to ensure that said first switching device (2) of said electronic control board (3) is maintained in conduction on a continual basis during the period and as long as it is in switched-on state. The operational state of the discharge pump (1) may require discontinuous operation as controlled by the pump driver board (4) although the triac (the first switching device, 2) of the electronic control board (3) is not switched off. In this case, the controllable load circuit ensures that a minimum amount of holding current is drawn so as to maintain said triac in conduction and accordingly maintain the microcontroller (6) of the pump driver board (4) continually energized.

Therefore, the control electronics of the power driver circuit (7) may dynamically lower the speed of the associated motor and stop the same while power supply to the pump driver board (4) remains uninterrupted. The power supply is interrupted when the first switching device (2) is turned off by the electronic control board (3) based on the preconfigured look-up table. When the first switching device (2), i.e. the triac of the electronic control board (3) is turned on but the discharge pump (1) is in its off period, the controllable load circuit of the pump driver board (4) is energized by the microcontroller (6) by turning a second switching device (8) on. On the other hand, when the first switching device (2) is on and the discharge pump (1) is functional, the second switching device (8) is turned off to prevent unnecessary power loss since the current needed by the discharge pump (1) is much greater than the minimum amount of the holding current.

According to an embodiment of the present invention, the controllable load circuit of said pump driver board (4) is realized in parallel with the terminals of the power supply stage (5) in the manner that the second switching device (8) is provided in series with a current limiting resistance (9). As a certain minimum amount of load current is required to hold the triac (the first switching device, 2) latched in the “on” state, this amount can be calculated based on the I-V curve characteristic of the triac so as to be limited by a current limiting resistance (9). The second switching device (8) of the controllable load circuit can be designed in the form of a triac, a BJT or a MOSFET, depending on the topology of the power supply stage (5). FIG. 4, demonstrating the the I-V curve characteristic of a triac, points B represent the minimum holding current I_{H}, points A represent the breakover voltage of the triac.

Said second switching device (8) of said controllable load circuit is therefore selectively energized and deenergized in response to the operational and non-operational state of the discharge pump (1) during the period which the first switching device (2) is in conduction.

Therefore, the main electronic control board (3) of the electrical household appliance, originally designed to power an electric motor on and off directly through a triac circuit, can also be used without any modification in feeding a pump driver board (4). A pump driver board (4) is accordingly supplied by the first switching device (2) in the form of a triac of the main electronic control board (3) so as to draw a minimum amount of current on a continual basis during conduction of the triac.

1. An electrical household appliance comprising an electronic control board (3) effecting functions of said electrical household appliance and a discharge pump (1), said discharge pump (1) being driven by an electric motor powered by said electronic control board (3) by means of a first switching device (2), said electrical household appliance further comprising a pump driver board (4) controlling the speed of said electric motor by means of a power driver circuit (7) and being powered by said electronic control board (3) by means of the first switching device (2), characterized in that said pump driver board (4) comprises a controllable load circuit operable to conduct a controllable-load current such that the first switching device (2) of the electronic control board (3) is maintained in conduction on a continual basis during the period it is in switched-on state.

2. An electrical household appliance as in claim 1, characterized in that said first switching device (2) is a triac.

3. An electrical household appliance as in claim 2, characterized in that said controllable load circuit of said pump driver board (4) comprises a second switching device (8) in series with a current limiting resistance (9).

4. An electrical household appliance as in claim 3, characterized in that the controllable load circuit is in parallel with the terminals of the power supply stage (5).

5. An electrical household appliance as in claim 4, characterized in that the controllable load circuit is powered by said power supply stage.

6. An electrical household appliance as in claim 3, characterized in that said second switching device (8) is realized in the form of a triac, a BJT or a MOSFET.

7. An electrical household appliance as in claim 3, characterized in that the second switching device (8) of the controllable load circuit is selectively energized and deenergized in response to the operational and non-operational state of the discharge pump (1) during the period which the triac is in conduction.
